(19) United States
(12) Patent Application Publication
(10) Pub. No.: US 2008/0255883 A1
(43) Pub. Date: Oct. 16, 2008

(54) Treatment Order Entry User Interface and Processing System

(75) Inventor: Hilari K. Jones, Salt Lake City, UT (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/100,738

(22) Filed: Apr. 10, 2008

Related U.S. Application Data
(60) Provisional application No. 60/911,986, filed on Apr. 16, 2007.

(51) Int. Cl. G06Q 50/00

(52) U.S. Cl. 705/3; 705/2

(57) ABSTRACT

A system enables a user to place large volumes of orders at one time as well as to assign the same order to multiple order sets and provides a method of using special formatting styles to group as well as differentiate orders in a shopping cart. A system provides data representing treatments for order for administration to a patient. The system includes a display processor for providing data representing at least one display image. The display image includes a data item indicating an individual treatment for order, data items indicating an order set incorporating multiple different treatments for order, and visual attributes indicating the different treatments are associated with the order set and are distinct from the individual treatment and the individual treatment is unassociated with an order set. A sorting processor sorts data items indicating the individual treatment for order and the different treatments for order for presentation in a sorted sequence in a display image by at least one of, (a) order set and (b) treatment description.

This is a non-provisional application of provisional application Ser. No. 60/911,986 filed Apr. 16, 2007, by H. K. Jones.

### FIELD OF THE INVENTION

This invention concerns a system for providing and sorting data representing individual treatments and sets of treatment for order for administration to a patient.

### BACKGROUND OF THE INVENTION

In known systems it is difficult or impossible to determine whether a given order (e.g., for a treatment such as a medication, service or procedure to be administered to a patient) is placed individually or as part of an order set. This results in confusion and potentially duplicate ordering which may impact patient safety. FIGS. 1-4 show display image windows listing individual orders and sets of orders for treatments to be administered to a patient as used in known systems. Specifically, FIGS. 1-4 show display image windows listing individual orders and sets of orders by Selection (FIG. 1), Department (FIG. 2), Order set (FIG. 3) and Description (FIG. 4). FIG. 1 lists orders and orders sets in the sequence in which they were placed in a shopping cart, for example. In this example, the shopping cart contains four distinct items as selected by the user: The ED-Cardiac Routine order set 101, an individual CBC order 103 (that duplicates an order already in order set 101), an individual order 105 for Radiology Requisition from Nursing (that duplicates an order already in order set 101) and an individual medication order 107 for Digoxin. Visually, it is difficult to determine which orders belong to an order set and which orders have been placed individually.

FIG. 2 lists orders and orders sets alphabetically within departments of a hospital, for example. In this example, two CBC orders 109 and 111 are listed under a Hematology department. It is not possible to determine which of these orders came from an ED-Cardiac Routine order set and which was placed individually. FIG. 3 lists facility-defined order sets in alphabetic order, followed by single orders grouped by department. In the FIG. 3 display image, order set name is less obvious than default department names that classify orders without a specific facility-defined set, and it remains difficult to determine where an order set begins and ends. FIG. 4 lists orders alphabetically, regardless of their association with an order set. In the FIG. 4 display image, duplicate orders exist for CBC and Radiology Requisition from Nursing, but it is unclear that one of the orders is associated with an order set and another was ordered individually. Known systems provide limited visual cues to differentiate order sets from individual orders and impair user identification of order set members and the associated order set. A system according to invention principles addresses these deficiencies and related problems.

### SUMMARY OF THE INVENTION

The inventors have advantageously recognized that there is a need for clear visual cues to differentiate orders that are placed as part of an order set versus individually and that users expend extra time reading through shopping cart selections and applying different sort options to identify the source of each order and make decisions about duplicate orders to keep or delete. A system enables concurrent placement of department and medication orders, either as individual orders or as part of predefined order sets, and groups orders that are commonly ordered together for a particular medical condition or procedure and enables a user to view and interpret an order shopping cart at a glance and identify the type and source of each order. A system provides data representing treatments for order for administration to a patient. The system includes a display processor for providing data representing at least one display image. The display image includes a data item indicating an individual treatment for order, data items indicating an order set incorporating multiple different treatments for order, and visual attributes indicating the different treatments are associated with the order set and are distinct from the individual treatment and the individual treatment is unassociated with an order set. A sorting processor sorts data items indicating the individual treatment for order and the different treatments for order for presentation in a sorted sequence in a display image by at least one of, (a) order set and (b) treatment description.

### BRIEF DESCRIPTION OF THE DRAWING

FIGS. 1-4 show display image windows listing individual orders and sets of orders for treatments to be administered to a patient as used in prior art systems.

FIG. 5 shows a system for providing data representing treatments for order for administration to a patient, according to invention principles.

FIGS. 6-9 show display image windows (and prior art windows for comparison) listing individual orders and sets of orders for treatments to be administered to a patient including visual attributes indicating different treatments associated with order sets and individual treatments unassociated with order sets, according to invention principles.

FIG. 10 shows an order processing system for providing data representing treatments for order for administration to a patient, according to invention principles.

FIGS. 11-14 show display image windows listing individual orders and sets of orders for a care plan for a patient including visual attributes indicating different treatments associated with order sets and individual treatments unassociated with order sets, according to invention principles.

FIG. 15 shows a flowchart of a process performed by a system for providing data representing treatments for order for administration to a patient, according to invention principles.

### DETAILED DESCRIPTION OF THE INVENTION

A system enables concurrent placement of department and medication orders, either as individual orders or as part of predefined order sets, and groups orders that are commonly ordered together for a particular medical condition or procedure. The system enables a user to view and interpret an order shopping cart at a glance and identify the type and source of each order. Orders placed in a Selected Orders list (also called a “shopping cart”) may be sorted by sequence of selection (first to last), hospital (or medical facility) department, order set (if relevant) or description (A to Z). The system allows a user to initiate placement of relatively large volumes of orders at one time. Further, a particular order may be assigned to multiple order sets and a user is able to view and interpret shopping cart contents at a glance. The system supports use of special formatting styles to group as well as differentiate orders in a shopping cart, allowing users to easily identify the type and source of each order based on a selected “list by” option, for example.

A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A processor may be electrically coupled to any other processor enabling interaction and/or communication therebetween. A display processor or generator is a known element comprising electronic circuitry or software or a combination of both for generating display images or portions thereof. A user interface comprises one or more display images enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UT), as used herein, comprises one or more display images, generated by a display processor and enabling user interaction with a processor or other device and associated data acquisition and processing functions.

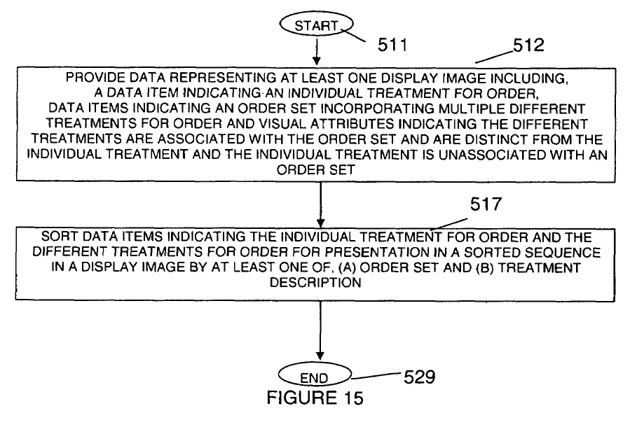

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UT display images in response to signals received from the input devices. In this way, the user interacts with the display image using the input devices, enabling user interaction with the processor or other device. The functions and process steps (e.g., of FIG. 15) herein may be performed automatically or wholly or partially in response to user command. An activity (including a step) performed automatically is performed in response to executable instruction or device operation without user direct initiation of the activity. Workflow comprises a sequence of tasks performed by a device or worker or both. An object or data object comprises a grouping of data, executable instructions or a combination of both or an executable procedure.

A workflow processor, as used herein, processes data to determine tasks to add to or remove from a task list or modifies tasks incorporated on, or for incorporation on, a task list. A task list is a list of tasks for performance by a worker or device or a combination of both. A workflow processor may or may not employ a workflow engine. A workflow engine, as used herein, is a processor executing in response to predetermined process definitions that implement processes responsive to events and event associated data. The workflow engine implements processes in sequence and/or concurrently, responsive to event associated data to determine tasks for performance by a device and or worker and for updating task lists of a device and a worker to include determined tasks. A process definition is definable by a user and comprises a sequence of process steps including one or more, of start, wait, decision and task allocation steps for performance by a device and or worker, for example. An event is an occurrence affecting operation of a process implemented using a process definition. The workflow engine includes a process definition function that allows users to define a process that is to be followed and includes an Event Monitor, which captures events occurring in a Healthcare Information System. A processor in the workflow engine tracks which processes are running, for which patients, and what step needs to be executed next, according to a process definition and includes a procedure for notifying clinicians of a task to be performed, through their worklists (task lists) and a procedure for allocating and assigning tasks to specific users or specific teams.

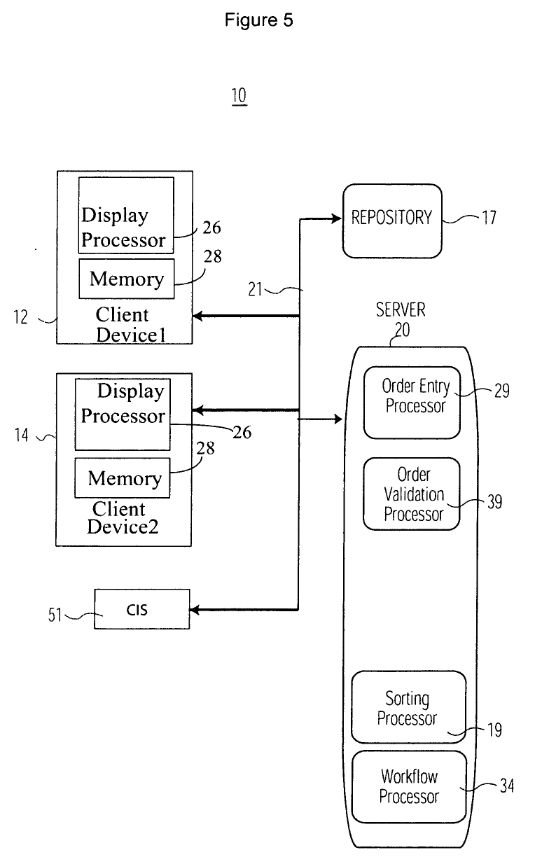

FIG. 5 shows system 10 for providing data representing treatments for order for administration to a patient. System 10 includes processing devices (e.g., workstations or portable devices such as notebooks, Personal Digital Assistants, cell phones) 12 and 14, at least one repository 17, Clinical Information System Application (CIS) 51 and server 20, inter-communicating via network 21. Processing devices 12 and 14 individually include memory 28 and display processor 26. Server 20 includes sorting processor 19, order entry processor 29, workflow processor 34 and order validation processor 39. Display processor 26 presents one or more display images enabling a user to, initiate execution of clinical information system 51 to provide a user with a clinical application display image identifying multiple different patients. The display images also enable user order entry via order entry processor 29. Order entry processor 29 enables a user to place orders for administration of treatments (e.g., medication) to a patient selected via an order entry application display image, for example. Workflow processor 34 initiates tracks and monitors task sequences including administration of medications by nurses ordered using order entry processor 29, in response to events.

Display processor 26 provides data representing display images for presentation on processing device 12 and 14. Specifically, display processor 26 provides data representing at least one display image including, a data item indicating an individual treatment for order, data items indicating an order set incorporating multiple different treatments for order and visual attributes indicating the different treatments are associated with the order set and are distinct from the individual treatment and the individual treatment is unassociated with an order set. Sorting processor 19 sorts data items indicating the individual treatment for order and the different treatments for order for presentation in a sorted sequence in a display image by at least one of, (a) order set and (b) treatment description. Order validation processor 39 indicates data items indicating duplicate treatments for order with a visual attribute.

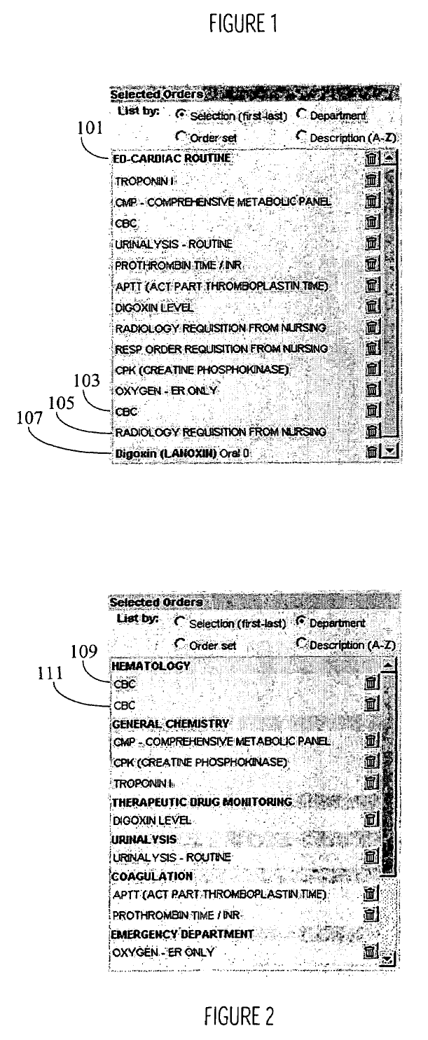

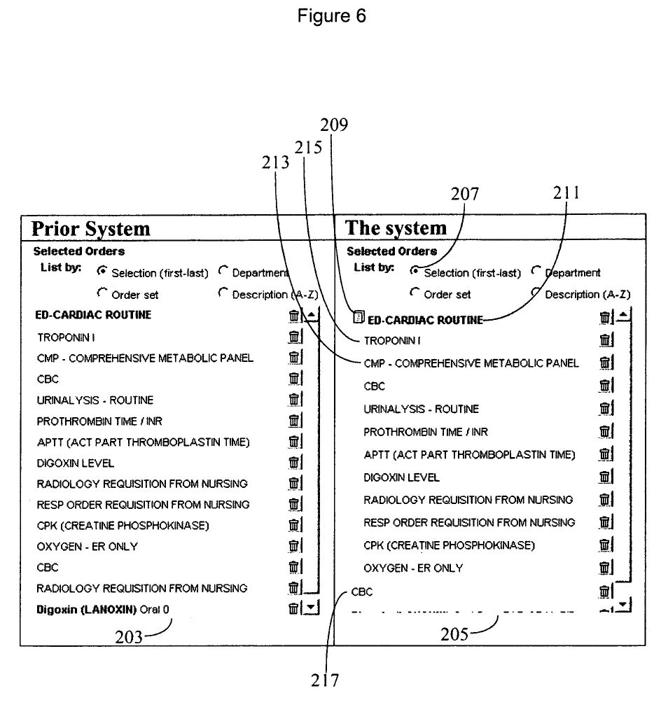

FIGS. 6-9 show display image windows (and prior art windows for comparison) provided by display processor 26 (FIG. 1) listing individual orders and sets of orders for treatments to be administered to a patient including visual attributes indicating different treatments associated with order sets and individual treatments unassociated with order sets. System 10 provides visual reinforcement of “list by” options available to sort items comprising treatments ordered for administration to a particular patient in a shopping cart. The system advantageously employs visual attributes (cues) comprising a combination of indentation, underlining, and icons enabling a user to quickly determine whether an order has been placed individually or as part of a set and, if part of a set of orders, the name of the associated set. The system also correlates visual cues with requested sort options to facilitate quick visual assessment of a shopping cart to allow users to differentiate order types and sources at a glance. The system flags order set members and thereby facilitates user identification of an origin of each order and makes order entry more efficient as users request combinations of order sets and individual orders. The system supports filtering order representative data items in a shopping cart by sequence of selection, department, order set, or description and improves user ability to identify and interpret the type and source of each order in the shopping cart.

FIG. 6 shows display image window 205 adjacent to the prior art image window 203 (which is the window of FIG. 1) for comparison and provided by display processor 26 (FIG. 1). Image window 205 lists individual orders and sets of orders for treatments to be administered to a patient by selection (option 207) in the system and includes visual attributes indicating different treatments associated with order sets and individual treatments unassociated with order sets. Specifically, image window 205 lists individual orders and sets of orders for treatments in a sequence in which they were placed in a shopping cart. Order sets of treatments (e.g., ED-Cardiac Routine 211) are grouped beneath a header that contains the set name 211 as well as an icon 209 (a visual attribute) for ease of identification. Orders, e.g., 213 and 215, within the order set are indented (a visual attribute) relative to the order set header element to emphasize their association with the set. An individual order for a treatment unassociated with an order set, e.g., order 217, displays on its own line and is not indented relative to order set headers.

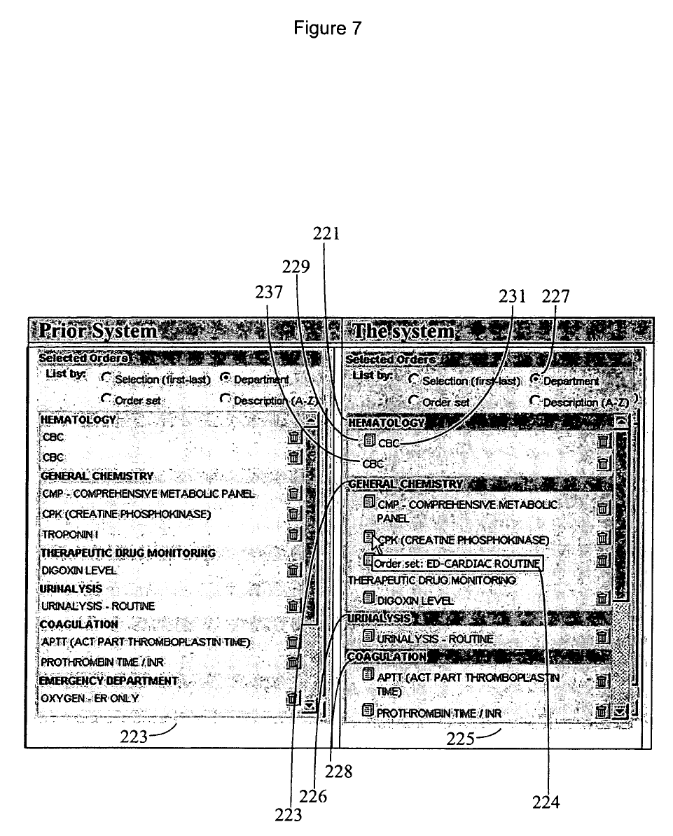

FIG. 7 shows display image window 225 adjacent to the prior art image window 223 (which is the window of FIG. 2) for comparison and provided by display processor 26 (FIG. 1). Image window 225 lists individual orders and sets of orders for treatments to be administered to a patient by department (option 227) and includes visual attributes indicating different treatments associated with order sets and individual treatments unassociated with order sets. Specifically, image window 225 lists individual orders and sets of orders for treatments alphabetically within departments (such as Hematology 221, General Chemistry 223, Urinalysis 226 and Coagulation 228). Individual orders belonging to an order set such as CBC order 231 are highlighted by being adjacent an order set icon 229. Further, in response to a user moving a cursor over a treatment order name of an order within an order set, display processor 26 displays the order set name in hover text 224. An individual order for a treatment unassociated with an order set, e.g., order 237, is presented with no icon.

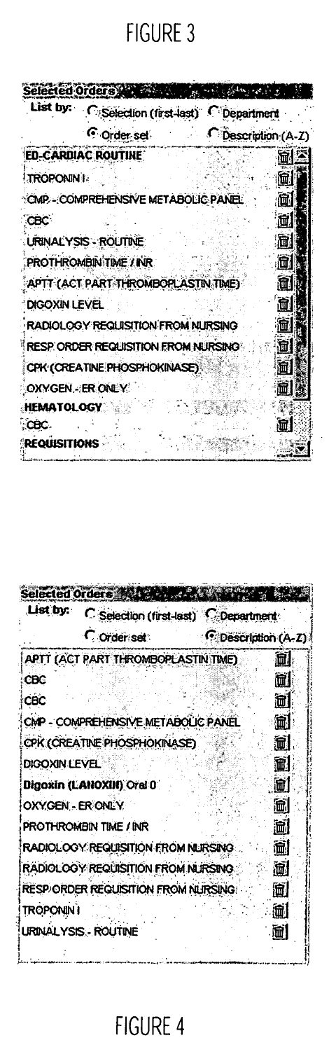

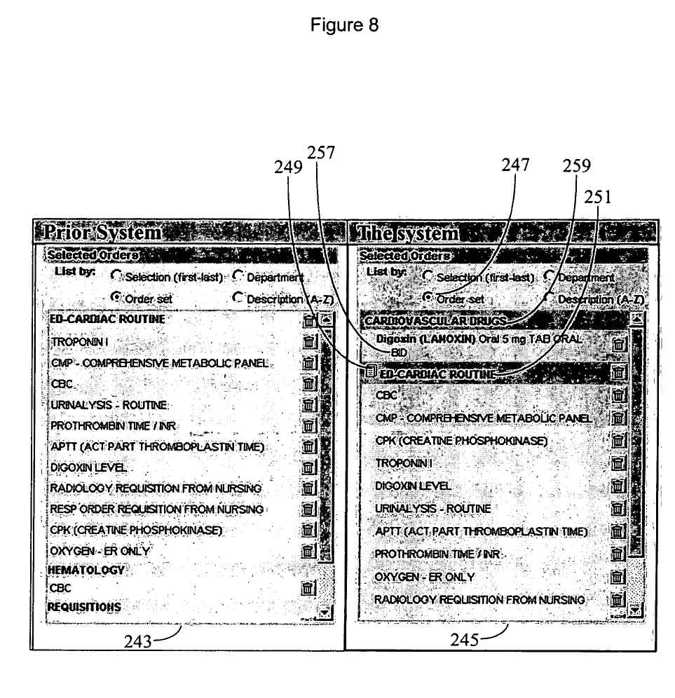

FIG. 8 shows display image window 245 adjacent to the prior art image window 243 (which is the window of FIG. 3) for comparison and provided by display processor 26 (FIG. 1). Image window 245 lists individual orders and sets of orders for treatments to be administered to a patient by order set in the system (option 247) and includes visual attributes indicating different treatments associated with order sets and individual treatments unassociated with order sets. Specifically. image window 245 lists facility-defined order sets in alphabetic order, followed by single orders grouped by department. Facility-defined order sets (e.g., ED-Cardiac Routine 251) are grouped beneath a header that contains the set name 251 as well as an icon 249 for ease of identification. Individual treatment orders such as order 257 within an order set are indented. Department-based groupings such as Cardiovascular Drugs 259 have no icon.

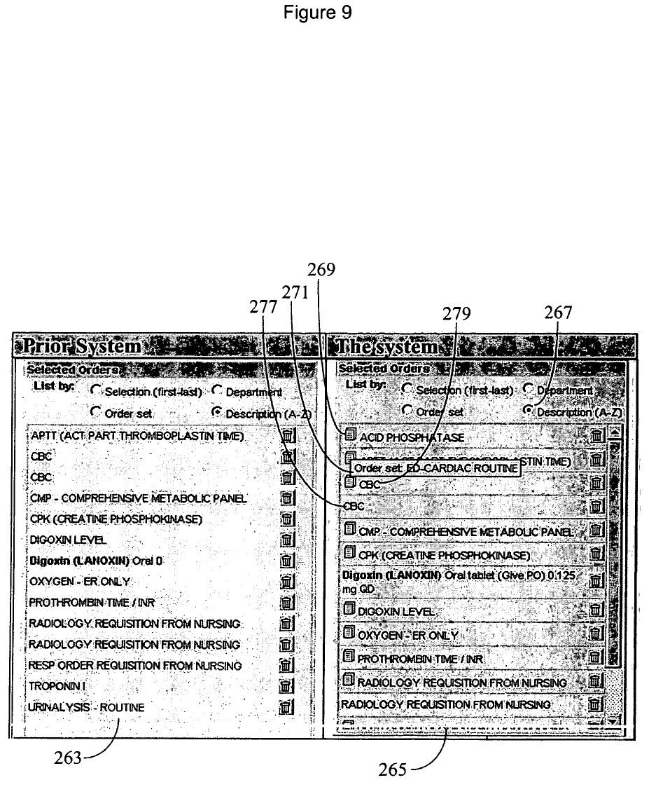

FIG. 9 shows display image window 265 adjacent to the prior art image window 263 (which is the window of FIG. 4) for comparison and provided by display processor 26 (FIG. 1). Image window 265 lists individual orders and sets of orders for treatments to be administered to a patient by description in the system (option 267) and includes visual attributes indicating different treatments associated with order sets and individual treatments unassociated with order sets. Specifically, image window 265 distinguishes individual treatment orders from those associated with treatment order sets. An icon such as icon 269 identifies individual treatment orders of treatment order sets. In response to a user placing a cursor over an item representing an order of an order set, hover text is displayed such as text 271 indicating the name of the order set. As an additional enhancement, duplicate orders (e.g., the standalone individual order CBC 277 and CBC order 279 of the order set) are highlighted (e.g., by shading, color, symbol or other visual attribute) so that a user may readily identify duplicate orders for removal from the list. A similar display including visual attributes is used in another embodiment to differentiate hierarchical components and sets of elements of a predetermined care plan sets in the process of supporting building a patient care and management plan. For example, care plan elements including orders, goals, and interventions are allocated an icon to identify a patient problem with which they are associated.

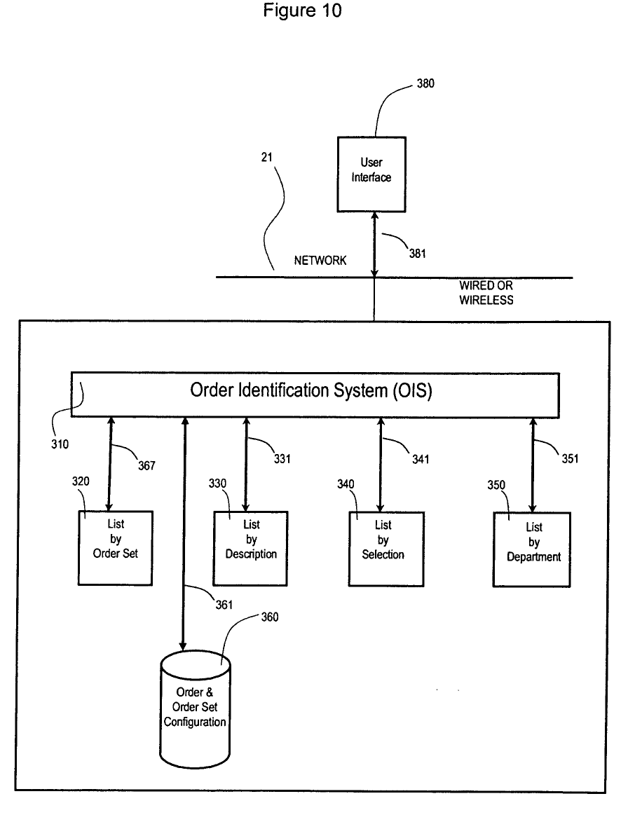

FIG. 10 shows an order processing system for providing data representing treatments for order for administration to a patient. A user interacts with user interface 380 attached through interface 381 to network 21 used to connect with Order Identification System (OIS) 310. The collection of treatment orders (or care plan elements) selected and placed into an Order Cart (“shopping cart”) have their appearance modified by OIS 310. If a user selects List by Order Set option (e.g., option 247 of FIG. 8), OIS 310 initiates the List by Order Set processor function 320 through interface 367. This selection initiates processing of current user selected order content and generation of the FIG. 8 orders menu list comprising an Order Cart (“shopping cart”) including the visual attributes as previously described. If a user selects the List by Description option (e.g., option 267 of FIG. 9), the OIS 310 initiates the List by Description processor function 330 through interface 331. This selection initiates processing of current user selected order content and generation of the FIG. 9 orders menu list comprising an Order Cart (“shopping cart”) including the visual attributes as previously described.

In response to a user selecting the List by Selection option (e.g., option 207 of FIG. 6), OIS 310 initiates the List by Selection processor function 340 through interface 341. This selection initiates processing of current user selected order content and generation of the FIG. 6 orders menu list comprising an Order Cart (“shopping cart”) including the visual attributes as previously described. In response to a user selecting the List by Department option (e.g., option 227 of FIG. 7), OIS 310 initiates the List by Department processor function 350 through interface 351. Data in Order & Order Set Configuration repository 360 contains configuration data determining the visual attributes of the image menus of FIGS. 6-9 and is accessed by the OIS 310 through interface 361.

The system differentiates individual treatment orders and orders belonging to order sets in a shopping cart by various sort criteria. The system also advantageously correlates visual cues with order relationships and requested sort options, improves user performance by facilitating quick scanning of a shopping cart of treatment orders and enables users to readily differentiate order types and sources at a glance. The formatting in one implementation uses CSS (cascading style sheets), for example, so that the CSS attributes may be tailored to present any number of alternative visual styles (e.g., different colors, backgrounds, or fonts; different icons). Other formatting systems may also be used. In web development, Cascading Style Sheets (CSS) is a stylesheet language used to describe the presentation of a document written in a markup language. Its most common application is to style web pages written in HTML and XHTML, but the language can be applied to any kind of XML document. CSS enables the separation of document content (written in HTML or a similar markup language) from document presentation (written in CSS). The CSS specifications are maintained by the World Wide Web Consortium (W3C).

FIGS. 11-14 show display image windows listing individual orders and sets of orders for a care plan for a patient including visual attributes indicating different treatments associated with order sets and individual treatments unassociated with order sets. Display processor 26 (FIG. 1) provides data representing at least one display image used to differentiate hierarchical components of predefined care driver sets from individually selected diagnoses, problems, goals, orders, and interventions used in building a multidisciplinary patient management plan. FIG. 11 shows display image window 405 provided by display processor 26. Image window (shopping cart) 405 lists patient care planning and care management items by selection in the sequence in which they were placed in the shopping cart in response to user activation of option 407. In this example, the shopping cart contains four different items selected by the user and includes visual attributes identifying a problem set differently to an individual selected intervention activity, for example. Specifically, a predetermined problem set with heading “Impaired gas exchange” 411 is indicated by icon 409, with the associated goals, orders, and interventions visually grouped and indented beneath the problem set heading. The shopping cart 405 includes non-indented individual items including, an individually selected intervention (“Turn every two hours”) 413, an individually selected intervention, (“Evaluate dressing every shift”) 415 and an individually selected goal (“Maintain skin integrity at optimal levels”) 417.

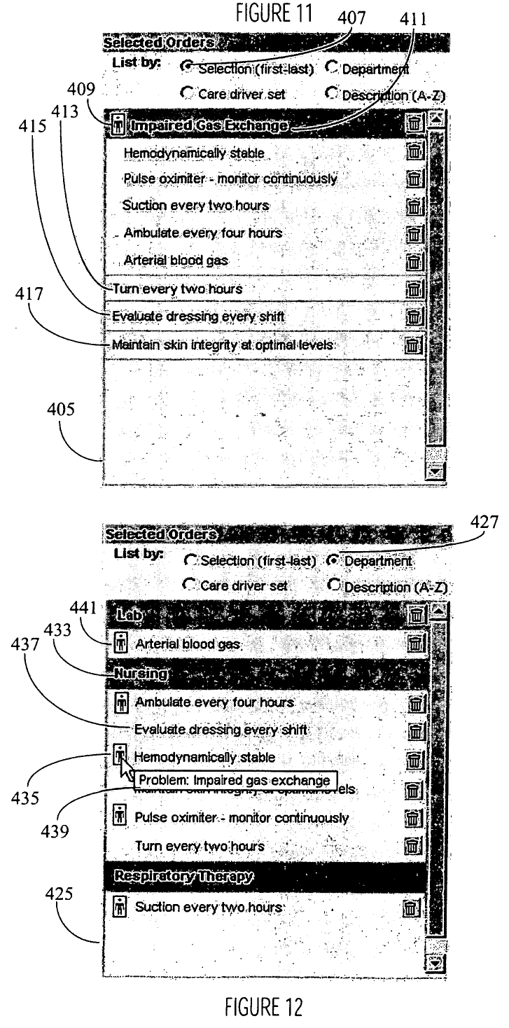

Image window (shopping cart) 425 of FIG. 12 lists patient care planning and care management items grouped by the department responsible for them e.g., nursing 433, in response to user activation of option 427. Shopping cart 425 contains individual items belonging to a care plan item set (e.g., Arterial blood gas item 441). Individual care plan items belonging to a care plan item set are indicated with a “care driver set” icon such as icon 435 adjacent the Hemodynamically stable item of an impaired gas exchange item set indicated by name in hover text 439. Such care plan item set hover text is displayed in response to a user superimposing a cursor over an individual care plan item belonging to a set. Individual care plan items that do not belong to a care plan item set, such as “Evaluate dressing every shift” (item 437) have no icon.

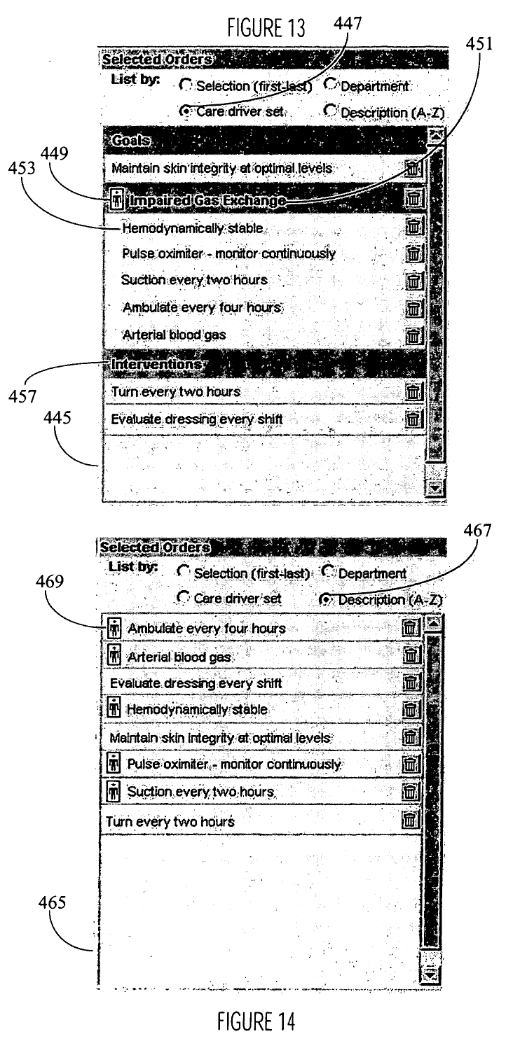

Image window (shopping cart) 445 of FIG. 13 lists patient care planning and care management items grouped by facility-defined care driver sets or general categories of care driver items (e.g., goals, interventions, orders), in response to user activation of option 447. Shopping cart 445 presents hospital facility-determined individual care plan items of a care plan item sets such as Impaired Gas Exchange set grouped beneath header 451 that contains the set name as well as icon 449 facilitating identification of a set. Further, orders, interventions, and goals within sets such as item 453 are indented relative to the care plan item set header 451. General care driver categories such as Interventions 457 have no icon or indentation. Image window (shopping cart) 465 of FIG. 14 lists patient care planning and care management items individually, in alphabetical order, in response to user activation of option 467. An icon such as icon 469 identifies care plan items of facility-determined care plan item sets. Further, hover text is displayed presenting the name of a care plan set in response to a user superimposing a cursor over an individual care plan item belonging to a set.

Display processor 26 (FIG. 1) provides display images presenting additional information for enhanced clinical decision support in ordering items for a patient using order entry processor 29 and in generating a patient management plan, for example. One or more display images indicates treatment order or care plan items that may need to be reviewed for clinical appropriateness, based on a patient diagnosis, medications, or allergies as well as items that may need to be reviewed for cost, or for which a lower-cost alternative is available. One or more display images also indicates duplicate or unnecessary treatment orders, based on a patient diagnosis and facility-determined rules as well as additional items to keep patients on a defined plan of care (e.g., preventive measures, items needed for research or chemotherapy protocols, items needed for a specific patient population).

FIG. 15 shows a flowchart of a process performed by a system for providing data representing treatments for order for administration to a patient. In step 512 following the start at step 51 1, display processor 26 (FIG. 1) provides data representing at least one display image. The display image includes a data item indicating an individual treatment for order, data items indicating an order set incorporating multiple different treatments for order and visual attributes indicating the different treatments are associated with the order set and are distinct from the individual treatment and the individual treatment is unassociated with an order set. The visual attributes indicating the different treatments are associated with the order set comprise at least one of indentation, a displayed icon, underlining, highlighting, shading, a symbol and spatial layout. The visual attributes also include hover text identifying at least one of, (a) an individual treatment and (b) an order set and the hover text is displayed in response to a user superimposing a cursor over a treatment name or related icon.

In a further patient care planning embodiments, the display image includes a data item indicating an individual care plan item, data items indicating a set of care plan items incorporating multiple different care plan items, and visual attributes indicating the different care plan items are associated with the set of care plan items and are distinct from the individual care plan item and the individual care plan item is unassociated with a set of care plan items. Care plan items comprise treatments for order for administration to a patient, expected outcomes and interventions (e.g., nurse or physician care services performed for a patient).

In step 517 sorting processor 19 (FIG. 1) sorts data items indicating the individual treatment for order and the different treatments for order for presentation in a sorted sequence in a display image on device 12 by at least one of, (a) order set and (b) treatment description. Sorting processor 19 also sorts data items indicating the individual treatment for order and the different treatments for order for presentation in a sorted sequence in a display image in response to at least one of, selection sequence of orders, type of hospital department or medication class associated with an order, the sequence the orders are selected by a user and hospital department associated with the order or order set. Sorting processor 19 further sorts the data items alphabetically or by order set in alphabetic sequence followed by individual treatments in alphabetic sequence or by treatment description.

In a patient care planning embodiment, sorting processor 19 sorts data items indicating the individual care plan item for order and the different care plan items for order for presentation in a sorted sequence in a display image by at least one of (a) set of care plan items and (b) care plan item description, (c) the sequence they are selected by a user and (d) by hospital department. Sorting processor 19 also sorts the data items by care plan set in alphabetic sequence followed by individual care plan item in alphabetic sequence. Order validation processor 39 indicates data items indicating duplicate treatments for order with a visual attribute. The process of FIG. 15 terminates at step 529.

The systems and processes of FIGS. 5-15 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The system visually emphasizes order relationships within a shopping cart and is applicable in any order entry system for which order metadata is maintained. For instance, an apparel e-commerce site that classifies products by wearer age or gender (e.g., men, women, children), type (e.g., trouser, blouses, skirts), or promotional package (e.g., shirt and tie and jacket or combination thereof) may use “department” and “order set” categories and associated visual presentations. The processes and applications may in alternative embodiments, be located on one or more (e.g., distributed) processing devices accessing a network linking the elements of FIG. 5. Further, any of the functions and steps provided in FIGS. 5-15 may be implemented in hardware, software or a combination of both and may reside on one or more processing devices located at any location of a network linking the elements of FIG. 5 or another linked network including the Internet.

What is claimed is:

1. A system for providing data representing treatments for order for administration to a patient, comprising:
a display processor for providing data representing at least one display image including,
a data item indicating an individual treatment for order,
data items indicating an order set incorporating a plurality of different treatments for order and
visual attributes indicating said different treatments are associated with said order set and are distinct from said individual treatment and said individual treatment is unassociated with an order set; and
a sorting processor for sorting data items indicating said individual treatment for order and said different treatments for order for presentation in a sorted sequence in a display image by at least one of, (a) order set and (b) treatment description.

2. A system according to claim 1, wherein
said visual attributes indicating said different treatments are associated with said order set comprise indentation.

3. A system according to claim 1, wherein
said visual attributes indicating said different treatments are associated with said order set comprise a displayed icon.

4. A system according to claim 1, wherein
said visual attributes indicating said different treatments are associated with said order set comprise indentation and a displayed icon.

5. A system according to claim 1, wherein
said visual attributes indicating said different treatments are associated with said order set comprise underlining.

6. A system according to claim 1, wherein
said visual attributes indicating said different treatments are associated with said order set comprise at least one of, (a) highlighting, (b) shading, (c) a symbol, (d) underlining and (e) spatial layout.

7. A system according to claim 1, wherein
said sorting processor sorts data items indicating said individual treatment for order and said different treatments for order for presentation in a sorted sequence in a display image in response to selection sequence of orders.

8. A system according to claim 1, wherein
said sorting processor sorts data items indicating said individual treatment for order and said different treatments for order for presentation in a sorted sequence in a display image in response to type of hospital department or medication class associated with an order.

9. A system according to claim 1, including
an order validation processor for indicating data items indicating duplicate treatments for order with a visual attribute.

10. A system according to claim 1, wherein
said sorting processor sorts data items indicating said individual treatment for order and said different treatments for order alphabetically.

11. A system according to claim 1, wherein
said sorting processor sorts data items indicating said individual treatment for order and said different treatments for order by at least one of, (a) the sequence they are selected by a user and (b) by hospital department.

12. A system according to claim 1, wherein
said sorting processor sorts data items indicating said individual treatment for order and said different treatments for order by order set in alphabetic sequence followed by individual treatments in alphabetic sequence.

13. A system according to claim 1, wherein
said visual attributes include hover text identifying at least one of, (a) an individual treatment and (b) an order set and said hover text is displayed in response to a user superimposing a cursor over a treatment name.

14. A system for providing data representing care plan items including treatments for order for administration to a patient, expected outcomes and interventions, comprising:
a display processor for providing data representing at least one display image including,
a data item indicating an individual care plan item,
data items indicating a set of care plan items incorporating a plurality of different care plan items and
visual attributes indicating said different care plan items are associated with said set of care plan items and are distinct from said individual care plan item and said individual care plan item is unassociated with a set of care plan items; and
a sorting processor for sorting data items indicating said individual care plan item for order and said different care plan items for order for presentation in a sorted sequence in a display image by at least one of, (a) set of care plan items and (b) care plan item description.

15. A system according to claim 14, wherein
care plan items comprise treatments for order for administration to a patient, expected outcomes and interventions and
said visual attributes indicating said different care plan items are associated with said set of care plan items comprise at least one of, (a) indentation, (b) an icon and (c) hover text.

16. A system according to claim 15, wherein
said sorting processor sorts data items indicating said individual care plan item and said set of care plan items by at least one of, (a) the sequence they are selected by a user and (b) by hospital department.

17. A system according to claim 14, wherein
said sorting processor sorts data items indicating said individual care plan item and said set of care plan items by care plan set in alphabetic sequence followed by individual care plan item in alphabetic sequence.

18. A system for providing data representing treatments for order for administration to a patient, comprising:
a display processor for providing data representing at least one display image including,
a data item indicating an individual treatment for order,
data items indicating an order set incorporating a plurality of different treatments for order and
visual attributes indicating said different treatments are associated with said order set and are distinct from said individual treatment and said individual treatment is unassociated with an order set, said visual attributes comprise at least one of, (a) indentation, (b) an icon and (c) hover text; and
a sorting processor for sorting data items indicating said individual treatment for order and said different treatments for order for presentation in a sorted sequence in a display image by at least one of, (i) order set and (ii) treatment description.

19. A system according to claim 18, wherein
said sorting processor sorts data items indicating said individual treatment for order and said different treatments for order by at least one of, (a) the sequence they are selected by a user and (b) by hospital department.
